(19) United States
(12) Patent Application Publication
(10) Pub. No.: US 2016/0006287 A1
(43) Pub. Date: Jan. 7, 2016

(54) MOBILE POWER SOURCE WITH A SINGLE INTERFACE, A BLUETOOTH KEYBOARD AND A PROTECTIVE SLEEVE

(71) Applicant: Shenzhen Paoluy Technology Co., Ltd, Shenzhen (CN)

(72) Inventor: Renkang Zhong, Shenzhen (CN)

(73) Assignee: Shenzhen Paoluy Technology Co., Ltd

(21) Appl. No.: 14/488,308

(22) Filed: Sep. 17, 2014

(30) Foreign Application Priority Data
Jul. 3, 2014 (CN) 201420367249.1

(51) Int. Cl. H02J 7/00

(52) U.S. Cl. CPC H02J 7/0068; H02J 7/007

(57) ABSTRACT

A mobile power source with a single interface, a Bluetooth keyboard and a protective sleeve is disclosed. The mobile power source comprises a voltage detecting circuit for detecting a voltage of an external power source, a current detecting circuit for detecting a current of an external load, a microcontroller, a charging controlling unit and a power supplying control unit. The microcontroller controls the charging of the built-in battery via the charging controlling unit when an access of the external power source is detected by the voltage detecting circuit and controls the power supplying to the external load via the power supplying control unit when an access of the external load is detected by the current detecting circuit. By implementing present application, one same interface can be used for both supplying power to the external load and charging the built-in battery via the external power source.

### CROSS-REFERENCE TO RELATED APPLICATION

This application claims the benefit of Chinese Patent Application No. 201420367249.1 filed on Jul. 3, 2014; the contents of which is hereby incorporated by reference.

### FIELD OF THE INVENTION

The present application relates to a mobile power source with a single interface, a Bluetooth keyboard and a protective sleeve.

### BACKGROUND OF THE INVENTION

As a power supplying manner, an interface of the existing mobile power source can only supplying power unilaterally. That is, the interface can only input power or output power. Accordingly, two interfaces, in which one is used for charging the mobile power source via an external power source and the other is used for supplying power to an external load, should be provided, which burdens the use of the mobile power source.

Taking a Bluetooth keyboard and a protective sleeve for example, the widely used Bluetooth keyboard is charged independently, so it should be charged after a period of time by itself. In additional, the Bluetooth keyboard is capable of charging the external load, such as a tablet PC, a mobile telephone and so on. Accordingly, the Bluetooth keyboard needs two interfaces, in which one is used for charging itself and the other is used for supplying power to an external load. That is, the input interface and the output interface are separated which burdens the use of the Bluetooth keyboard.

Furthermore, a protective sleeve of a mobile telephone or a tablet PC is widely used for its favorable protection. The mobile telephone or the tablet PC is power consuming, so the users always deploy a mobile power source individually. However, caring a mobile power source is inconvenient. Furthermore, when using a mobile power source, two interfaces should be used for power charging and power supplying separately.

### SUMMARY OF THE INVENTION

A first objective of the present application is providing a mobile power source with a single interface, a Bluetooth keyboard and a protective sleeve, aiming at solving the technical problems mentioned above.

According to one aspect, a mobile power source with a single interface for charging a built-in battery and supplying power to an external load is provided, wherein, the single interface comprises a power source terminal and a ground terminal. The mobile power source with a single interface comprises a voltage detecting circuit connecting with the power source terminal of the single interface for detecting a voltage of an external power source, a current detecting circuit connecting with the ground terminal of the single interface for detecting a current of an external load, a microcontroller, a charging controlling unit and a power supplying control unit connecting with an output terminal of the microcontroller separately; wherein, the voltage detecting circuit and the current detecting circuit connect with an input terminal of the microcontroller.

The microcontroller controls the charging of the built-in battery via the charging controlling unit when an access of the external power source is detected by the voltage detecting circuit. The microcontroller further controls the power supplying to the external load via the power supplying control unit when an access of the external load is detected by the current detecting circuit.

Advantagely, the charging controlling unit comprises a first switching unit connecting with the microcontroller and a charging managing module connecting with the first switching unit. The microcontroller switches on the first switching unit when the access of the external power source is detected by the voltage detecting circuit. The voltage of the external power source accessed from the single interface charges the built-in battery via the charging managing module. The power supplying control unit comprises a second switching unit and a boost circuit both connected with the microcontroller. Wherein, the boost circuit connects with the built-in battery and the second switching unit. The microcontroller switches on the second switching unit and operates the boost circuit for boosting a voltage of the built-in battery and supplying power to the external load connecting with the single interface via the second switching unit when the access of the external load is detected by the current detecting circuit.

Advantagely, the microcontroller has a model of SH69P482.

Advantagely, the first switching unit comprises a MOS transistor Q5, a triode Q6 and a resistor R24. A base of the triode Q6 connects with a ninth pin of the microcontroller. A collector of the triode Q6 connects with a grid of the MOS transistor Q5 and a source of the MOS transistor Q5 via the resistor R24. A drain of the MOS transistor Q5 connects with the charging managing module, and an emitter of the triode Q6 is grounded.

Advantagely, the boost circuit comprises a control chip having a model of MT3608 and an outputting circuit connected with the control chip. The outputting circuit comprises an inductor L1, a diode D3, a capacitor C15, a resistor R29 and a resistor R34. A fourth pin of the control chip connects with a third pin of the microcontroller. A first pin of the control chip connects with the built-in battery via the inductor L1 and meanwhile connects with an anode of the diode D3. A cathode of the diode D3 connects with one end of the capacitor C15 and one end of the resistor R29 separately. Other end of the capacitor C15 is grounded, and other end of the resistor R29 is grounded via the resistor R34.

Advantagely, the second switching unit comprises a MOS transistor Q7, a triode Q8 and a resistor R28. A base of the triode Q8 connects with the third pin of the microcontroller. A collector of the triode Q8 connects with a grid of the MOS transistor Q7 and one end of the resistor R28. Other end of the resistor R28 connects with a source of the MOS transistor Q7 and the cathode of the diode D3 separately. A drain of the MOS transistor Q7 connects with the power source terminal of the single interface.

Advantagely, the voltage detecting circuit comprises a resistor R17 and a resistor R23. One end of the resistor R17 connects with the power source terminal of the single interface, and other end of the resistor R17 is grounded via the resistor R23. A connection node of the resistor R17 and the resistor R23 connects with a sixteenth pin of the microcontroller.

Advantagely, the current detecting circuit comprises a resistor ER9, a resistor R33 and a capacitor C16. One end of the resistor ER9 connects with the ground terminal of the single interface, other end of the resistor ER9 is grounded via the resistor R33 and the capacitor C16 connected in series. A connection node of the resistor R33 and the capacitor C16 connects with a seventh pin of the microcontroller.

According to another aspect, a Bluetooth keyboard comprising above mobile power source with a single interface is provided.

According to a further aspect, a protective sleeve comprising a protective sleeve body arranged with above mobile power source with a single interface is provided.

When implementing the mobile power source with a single interface, Bluetooth keyboard and protective sleeve of the present invention, one same interface can be used for both supplying power to the external load, such as a tablet PC, a mobile telephone and so on, and charging the built-in battery via the external power source. The microcontroller switches on the first switching unit when the access of the external power source is detected by the voltage detecting circuit via detecting the voltage of the external power source. The microcontroller switches on the second switching unit and operates the boost circuit for boosting a voltage of the built-in battery and supplying power to the external load via the second switching unit when the access of the external load is detected by the current detecting circuit via detecting the load current. Accordingly, the present application saves interface and facilitates the user by employing one interface for charging and power supplying.

In additional, the Bluetooth keyboard having above mobile power source with a single interface, just needs one same interface for both supplying power to the external load and charging the built-in battery via the external power source. Furthermore, the protective sleeve having above mobile power source with a single interface on one hand extends its original function, and on the other hand just needs one same interface for both supplying power to the external load and charging the built-in battery via the external power source.

### BRIEF DESCRIPTION OF THE DRAWINGS

The present invention is further described with reference to the accompanying drawings and embodiments in the following. In the figures:

FIG. 1 is a diagram illustrating an embodiment of the mobile power source with a single interface according to present application.

FIG. 2 is a circuit diagram showing the periphery circuit of the microcontroller.

FIG. 3 is a circuit diagram showing the connection of the current detecting circuit and the single interface.

FIG. 4 is a circuit diagram of the charging managing module in FIG. 1.

FIG. 5 is a circuit diagram of the first switching unit and the second switching unit in FIG. 1.

FIG. 6 is a circuit diagram of the boost circuit in FIG. 1.

FIG. 7 is a circuit diagram of the periphery circuit of the Bluetooth module according to an embodiment of the Bluetooth keyboard according to present application.

FIG. 8 is a circuit diagram of the third switching unit according to an embodiment of the Bluetooth keyboard according to present application.

FIG. 9 illustrates the Bluetooth keyboard according to present application charging the external load via the single interface.

FIG. 10 illustrates an external power source charging the Bluetooth keyboard via the single interface shown in FIG. 9.

FIG. 11 illustrates the protective sleeve according to present application charging the tablet PC using the protective sleeve via the single interface.

FIG. 12 illustrates the external power source charging the protective sleeve via the single interface shown in FIG. 11.

### DETAILED DESCRIPTION OF THE PREFERRED EMBODIMENT

These and other advantage, aspect and novel features of the present invention, as well as details of an illustrated embodiment thereof, will be more fully understand from the following description and drawings.

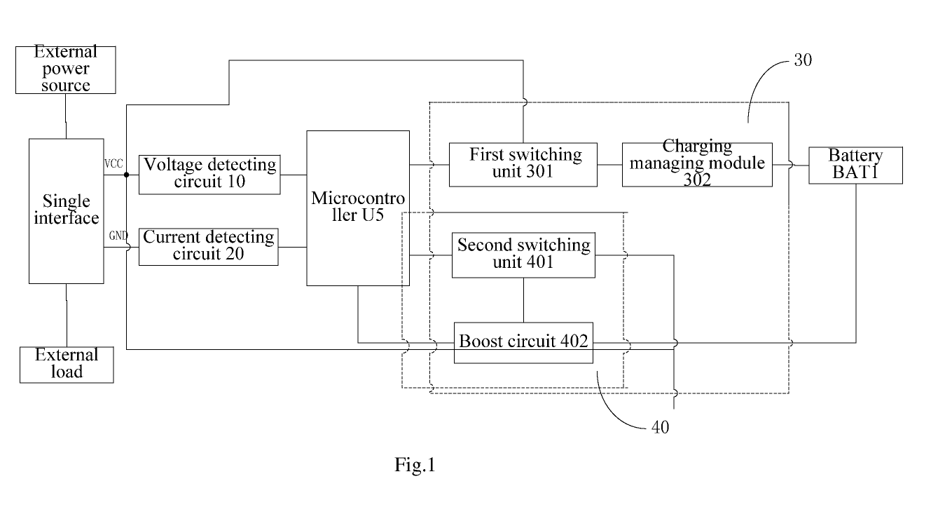

FIG. 1 is a diagram illustrating an embodiment of the mobile power source with a single interface according to present application. In which, the external power source charges the built-in battery via the single interface and the built-in battery charges the external load, such as a tablet PC, a mobile telephone and so on, via the single interface. As shown in FIG. 1, the mobile power source with a single interface comprises a voltage detecting circuit 10 connecting with the power source terminal of the single interface which is pin VCC, a current detecting circuit 20 connecting with the ground terminal of the single interface which is pin GND, a microcontroller U5, a charging controlling unit 30 and a power supplying control unit 40 connecting with an output terminal of the microcontroller U5 separately. The voltage detecting circuit 10 and the current detecting circuit 20 connect with an input terminal of the microcontroller U5.

Specially, the charging controlling unit 30 comprises a first switching unit 301 connecting with the microcontroller U5 and a charging managing module 302 connecting with the first switching unit 301. When an external power source is accessed, the voltage detecting circuit 10 will detect a voltage input and then output a first level signal. Receiving the first level signal by the microcontroller U5 means a voltage is inputted and the single interface connects with the external power source. The microcontroller U5 outputs a control signal for switching on the first switching unit 301. Then the voltage of the external power source accessed from the single interface charges the built-in battery BAT1 via the charging managing module 302. The power supplying control unit 40 comprises a second switching unit 401 and a boost circuit 402 both connected with the microcontroller U5. Wherein, the boost circuit 402 connects with the built-in battery BAT1 and the second switching unit 402. When an external load (such as a tablet PC, a mobile telephone and so on,) is accessed, the current detecting circuit will detect a load current and output a second level signal to the microcontroller U5. Receiving the second level signal by the microcontroller U5 means the single interface connects with the external load. The microcontroller U5 outputs a control signal for switching on the second switching unit 401 and operating the boost circuit 402. The boost circuit 402 boosts a voltage of the built-in battery and then supply the voltage to the external load connecting with the single interface via the second switching unit 401.

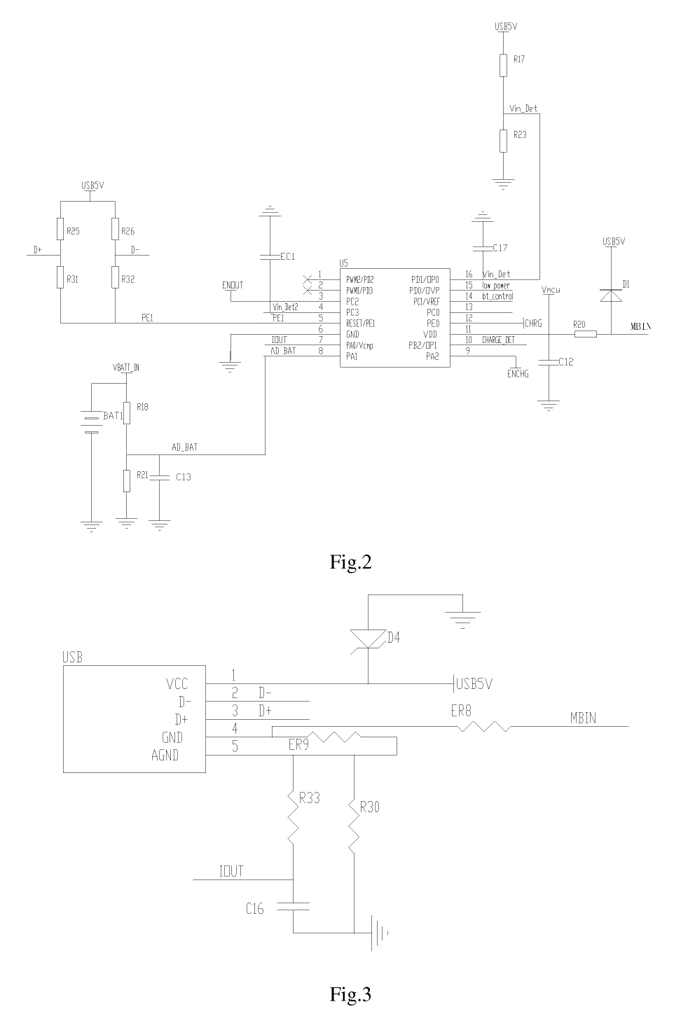

In present embodiment, the microcontroller has a preferable model of SH69P482. FIG. 2 is a circuit diagram showing the periphery circuit of the microcontroller. For example and without limitation, the single interface can be a USB interface. However, other types of interfaces are also practicable. For example, an interface converter can be used for converting the interfaces to be desired ones.

The voltage detecting circuit 10 comprises a resistor R17 and a resistor R23. The connection node (shown with an electric sign of Vin_Det) of the resistor R17 and the resistor R23 connects with a sixteenth pin of the microcontroller U5. One end of the resistor R17 connects with the power source terminal of the USB interface (shown with an electric sign of USB5V). When the USB interface connects with the external power source, the microcontroller U5 detects a voltage input on its sixteenth pin via the voltage division of the resistor R17 and resistor R23 and then charges built-in battery BAT1. The current detecting circuit 20 comprises a resistor ER9, a resistor R33 and a capacitor C16. As shown in FIG. 3, one end of the resistor ER9 connects with the ground terminal GND of the USB interface, and the other end of the resistor ER9 is grounded via the resistor R33 and the capacitor C16 connected in series and is further grounded via the resistor R30. The connection node (shown with an electric sign of IOUT) of the resistor R33 and the capacitor C16 connects with a seventh pin of the microcontroller U5. When the USB interface connects with the external load, the microcontroller U5 detects a load input on its seventh pin and then charges the external load.

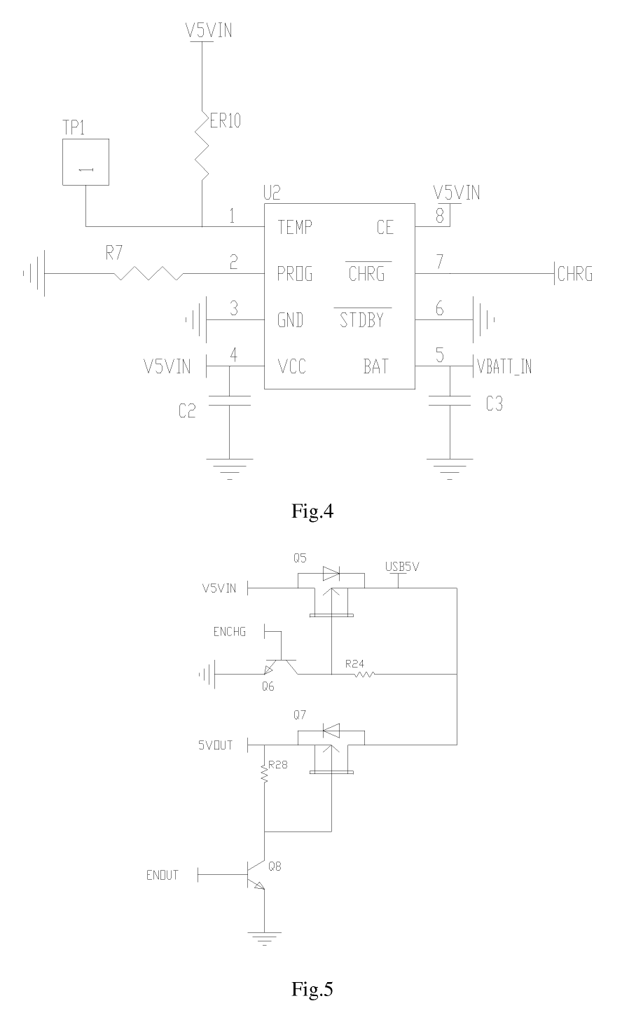

As shown in FIG. 4, the charging managing module 302 comprises a charging managing chip U2 and some periphery elements (such as a resistor R7, a capacitor C3 and capacitor C2). In present embodiment, the charging managing chip U2 has a preferable model of TP4056. As shown in FIG. 5, the first switching unit 301 comprises a P-type MOS transistor Q5, a triode Q6 and a resistor R24. Combining FIG. 2 and FIG. 5, a base of the triode Q6 (shown with an electric sign of ENCHG) connects with a ninth pin of the microcontroller U5. A collector of the triode Q6 connects with a grid of the MOS transistor Q5 and a source of the MOS transistor Q5 via the resistor R24. A drain of the P-type MOS transistor Q5 (shown with an electric sign of V5VIN) connects with the fourth and eighth pins of the charging managing chip U2 and an emitter of the triode Q6 is grounded.

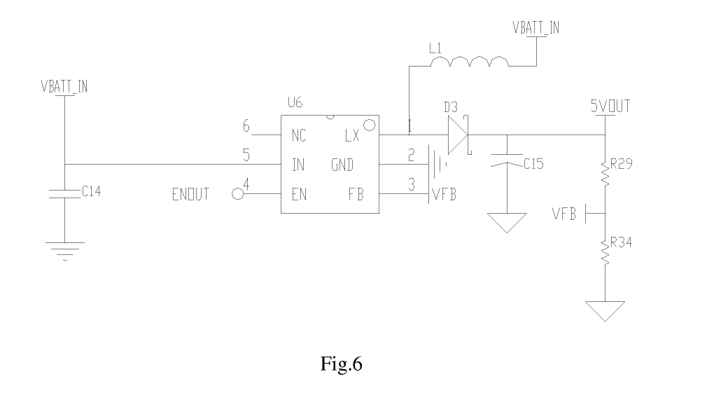

As shown in FIG. 6, the boost circuit 402 comprises a control chip U6 and an outputting circuit connected with the control chip U6. In present embodiment, the control chip U6 has a preferable model of MT3608. The outputting circuit concretely comprises an inductor L1, a diode D3, a capacitor C15, a resistor R29 and a resistor R34. A fourth pin of the control chip U6 connects with a third pin of the microcontroller U5. A first pin of the control chip U6 connects with the built-in battery BAT1 (shown with an electric sign of VBATT_IN) via the inductor L1 and meanwhile connects with an anode of the diode D3. A cathode of the diode D3 connects with one end of the capacitor C15 and one end of the resistor R29 separately. Other end of the capacitor C15 is grounded, and other end of the resistor R29 is grounded via the resistor R34.

Referring FIG. 5 again, the second switching unit 401 comprises a P-type MOS transistor Q7, a triode Q8 and a resistor R28. A base of the triode Q8 connects with the third pin of the microcontroller U5. A collector of the triode Q8 connects with a grid of the P-type MOS transistor Q7 and one end of the resistor R28. Other end of the resistor R28 connects with a source of the P-type MOS transistor Q7 and the cathode of the diode D3 separately. A drain of the P-type MOS transistor Q7 connects with the power source terminal of the single interface (shown with an electric sign of USB5V). A source of the P-type MOS transistor Q7 further connects with the cathode of the diode D3.

Referring FIG. 2 again, an identify circuit for charging Apple devices is provided. The identify circuit comprises a resistor R25, a resistor R26, a resistor R31 and a resistor R32. The connection node of the resistor R25 and the resistor R31 connects with the data transmission terminal D+ of the USB interface, and the connection node of the resistor R26 and the resistor R32 connects with the data transmission terminal D− of the USB interface. The connection node of the resistor R31 and the resistor R32 connects with the fifth pin of the microcontroller U5. The user can determine whether the USB interface is charging an apple device based on the signal received by the fifth pin.

Now, the work principle of the mobile power source with a single interface according to present application is introduced as follows combining FIG. 1-6.

When the USB interface has neither power source access nor load access, the microcontroller U5 is in a sleeping mode.

When the USB interface connects an external power such as a 5V power source, then the connection node of the resistor R17 and resistor R23 has a voltage output (a first level signal). If the microcontroller U5 detects a signal input on its sixteenth pin, the USB interface connects an external power. Now, the built-in battery BAT1 should be charged. Concretely, when the microcontroller U5 detects the first level signal input on its sixteenth pin, it outputs a high level signal to the base of the triode Q6 via its ninth pin. The triode Q6 is switched on as its collector connects with the power source terminal of the USB interface and its emitter is grounded. As the collector of the triode Q6 connects with a grid of the P-type MOS transistor Q5, and the source of the P-type MOS transistor Q5 connects with the power source terminal of the USB interface, so the P-type MOS transistor Q5 is switched on now. In this way, the external 5V power source charges the charging managing chip U2 via the P-type MOS transistor Q5 and the charging managing chip U2 charges the built-in battery BAT1 via its fifth pin after it is turned on.

When the USB interface connects an external load such as a tablet PC, a mobile telephone and so on, then the connection node of the resistor R23 and the capacitor C16 outputs a second level signal representing a load current to the seventh pin of the microcontroller U5. If the microcontroller U5 detects the second level signal on its seventh pin, the USB interface connects an external load. Now, the external load should be charged. Concretely, when the microcontroller U5 detects the second level signal input on its seventh pin, it outputs a high level signal to the base of the triode Q8 and the fourth pin of the control chip U6 via its third pin. After receiving the high level signal via its fourth pin, the control chip U6 is switched on for boosting the battery voltage to 5V. Then the 5V voltage is outputted to the source of the P-type MOS transistor Q7 by the outputting circuit comprising an inductor L1, a diode D3, a capacitor C15, a resistor R29 and a resistor R34. Meanwhile, as the triode Q8 has a high lever at its base, the triode Q8 is switched on, and thus the P-type MOS transistor Q7 is also switched on. Then the 5V voltage is outputted to the power source of the USB interface via the P-type MOS transistor Q7 and then charge the external load.

Accordingly, when implementing the mobile power source with a single interface, of the present invention, one same interface can be used for both supplying power to the external load, such as a tablet PC, a mobile telephone and so on, and charging the built-in battery via the external power source. The microcontroller switches on the first switching unit when the access of the external power source is detected by the voltage detecting circuit via detecting the voltage of the external power source. The microcontroller switches on the second switching unit and operates the boost circuit for boosting a voltage of the built-in battery and supplying power to the external load via the second switching unit when the access of the external load is detected by the current detecting circuit via detecting the load current. Accordingly, the present application saves interface and facilitates the user by employing one interface for charging and power supplying.

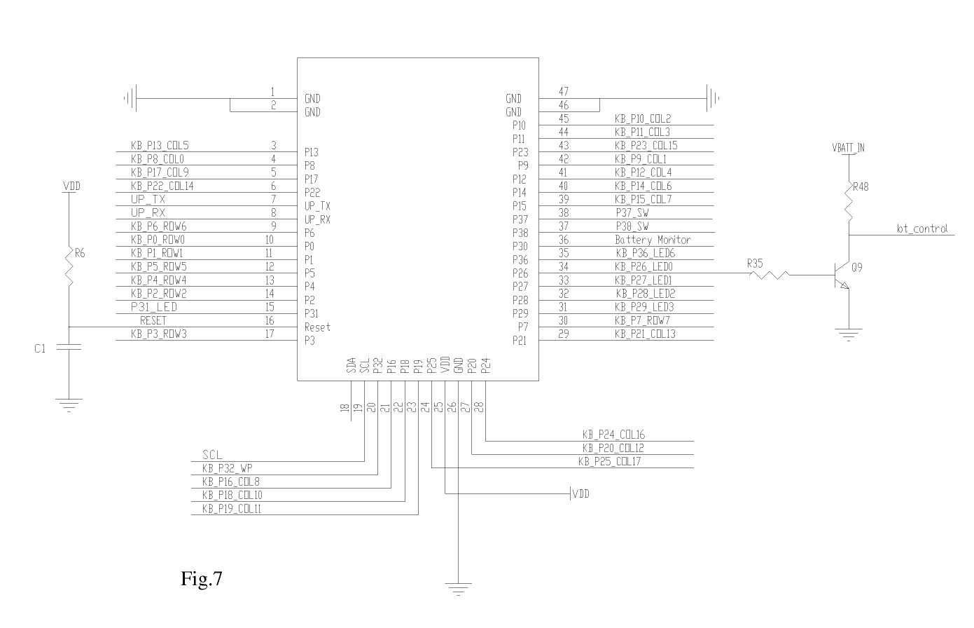

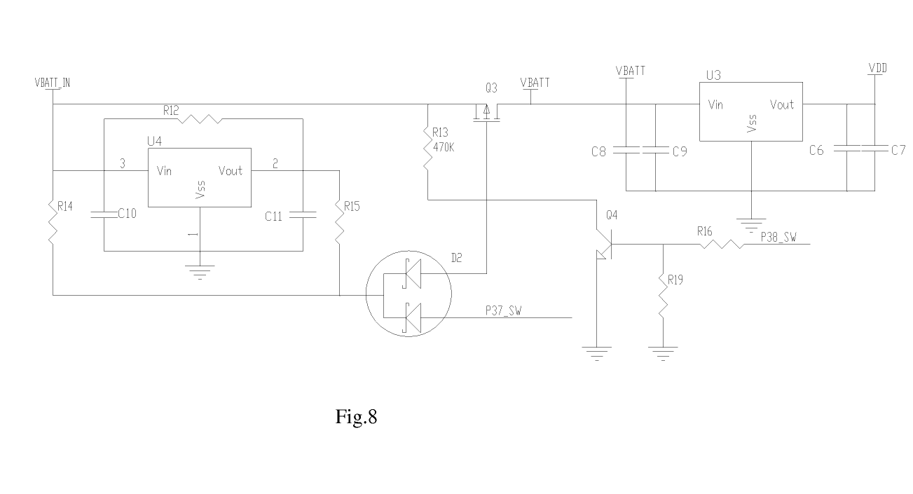

The present application has further provided a Bluetooth keyboard using the above mobile power source with a single interface as a standby power source. Accordingly, the Bluetooth keyboard just needs one same interface for both supplying power to the external load and charging the built-in battery via the external power source. For example, the Bluetooth keyboard can comprises a housing, keys arranged on the housing surface, and a circuit board arranged in the housing. The circuit board comprises a Bluetooth circuit board and a power source control board. Specially, the power source control board comprises the mobile power source with a single interface (such as a USB interface) shown in FIG. 1-6. The mobile power source with a single interface has been described in detail above, and is not described for conciseness. The Bluetooth circuit board mainly comprises a Bluetooth module U1 and a third switching unit. FIG. 7 is a circuit diagram of the periphery circuit of the Bluetooth module U1. In present embodiment, the Bluetooth module U1 having a preferable model of BT3GMD-B47P is used for controlling the switching on and off of the Bluetooth keyboard, wireless connection between the keyboard and the tablet PC and keyboard functions. Combining FIG. 2, 7-8, the third switching unit comprises a regulator chip U3 for regulating the voltage of the battery BAT1 and supplying regulated voltage to the Bluetooth module U1 and a hall switch U4 for switching on or off the keyboard. In present embodiment, the regulator chip U3 has a preferable model of LDO 2P8V, and the hall switch U4 has a preferable model of YX4913.

The Bluetooth keyboard connects with the tablet PC by a magnet attachment technology, such that the Bluetooth keyboard is used as the keyboard of the tablet PC. Concretely, when the magnet gets close to the hall switch U4, the first pin and the second pin of the hall switch U4 communicate with each other, then the hall switch U4 outputs a lower level form its second pin. Meanwhile, the P-type MOS transistor Q3 has a lower level at its grid, then the P-type MOS transistor Q3 is switched on. Accordingly, the voltage of the built-in battery BAT1 (shown with an electric sign of VBATT_IN) is regulated by the regulator chip U3 and then supplied to the hall switch U4 via its second pin. In such a way, the Bluetooth keyboard is switched on. The Bluetooth module U1 outputs a high level from its thirty-seventh pin and thirty-eighth pin. As the hall switch U4 outputs a lower level form its second pin now and the diode D2 (preferably having a model of BAT54C) connects with the thirty-eighth pin of the Bluetooth module U1, so the level of the thirty-eighth pin is pulled down, and the base of the triode Q4 connecting with the thirty-seventh pin of the Bluetooth module U1 receives a high level. Then the triode Q4 is switched on, and the triode Q4 outputs a low level at its collector, then the triode Q3 is switched on for supplying power to the Bluetooth module U1, thus, the Bluetooth module U1 operates normally.

When the magnet gets away from the hall switch U4, the second pin of the hall switch U4 outputs a high level. However, as the triode Q4 is still switched on, the Bluetooth keyboard still works. In additional, as the second pin of the hall switch U4 outputs a high level, the thirty-eighth pin of the hall switch U4 outputs a high level too. When the Bluetooth module U1 detects the high level from the thirty-eighth pin, it sends a Bluetooth disconnection signal to the tablet PC for three times, then the tablet PC would be disconnected from the Bluetooth keyboard. Then, Bluetooth module U1 changes the high level from the thirty-seventh pin to a low level, so as to switch off the triode Q4, and the P-type MOS transistor Q3, and finally the Bluetooth keyboard.

Combining FIGS. 2 and 7, the above Bluetooth keyboard further comprises a battery power detecting circuit between the Bluetooth module U1 and microcontroller U5. The battery power detecting circuit comprises a triode Q9, a resistor R35 and a resistor R48. The triode Q9 connects with the fourteenth pin of the microcontroller U5 via its collector having a high level, and the thirty-fourth pin of the microcontroller U5 via its base having a low level normally. When the Bluetooth keyboard touches off a battery power detecting key (shown with an electric sign of KB P26 LEDO), the Bluetooth module U1 outputs a high level at its thirty-fourth pin, so the triode Q9 receives a high level at its base, thus the triode Q9 is switched on, and the high level at its collector is pulled down. The connection node of the triode Q9 and the resistor R48 (shown with an electric sign of bt control) outputs a low level. When microcontroller U5 detects a low level at its fourteenth pin, it will detect the battery power.

In a preferable embodiment, the battery power detecting circuit further comprises a resistor R18, a resistor R21 and a capacitor C13. The microcontroller U5 connects with the connection node (shown with an electric sign of AD_BAT) of the resistor R18 and resistor R21 via its eighth pin. When the microcontroller U5 detects that the battery power is higher than a scheduled value (such as 3.8V), it turns on a green indicator light (green LED) for 5 seconds. When the microcontroller U5 detects that the battery power is between 3.4-3.8V, it turns on a green indicator light (green LED) and a red indicator light (red LED) for 5 seconds synchronously. In which, the when the green indicator light and the red indicator light (red LED) are lightened, a yellow light can be produced for 5 seconds. The green indicator light and the red indicator light (red LED) are connected between the tenth pin and fifteenth pin of the microcontroller U5. In additional, during the charging process of the Bluetooth keyboard to a mobile phone or a tablet PC via the USB interface, when the battery power is lower than a scheduled value (such as 3.4V), the red indicator light is lightened for a long time to remind that the battery power is too low and the Bluetooth keyboard should be charged. When the battery power is lower than another scheduled value (such as 3.2V), the microcontroller U5 will stop the boost circuit 402 from supplying power to the external load and keep the battery power for normal operation of the Bluetooth keyboard.

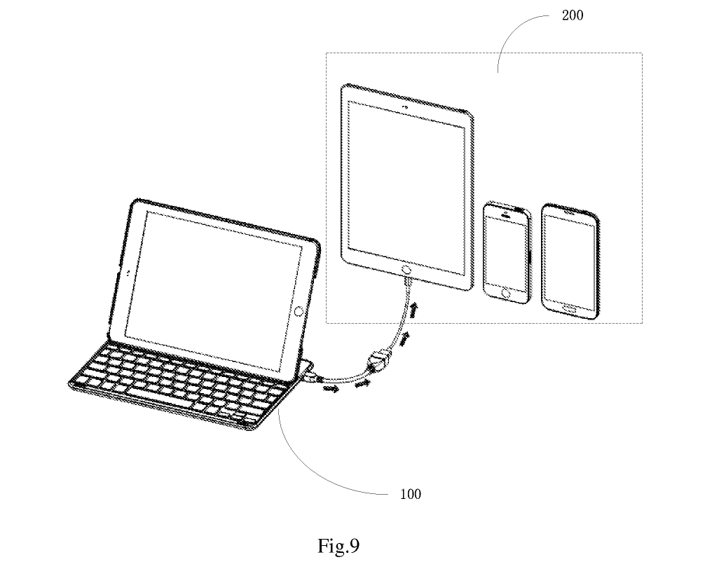

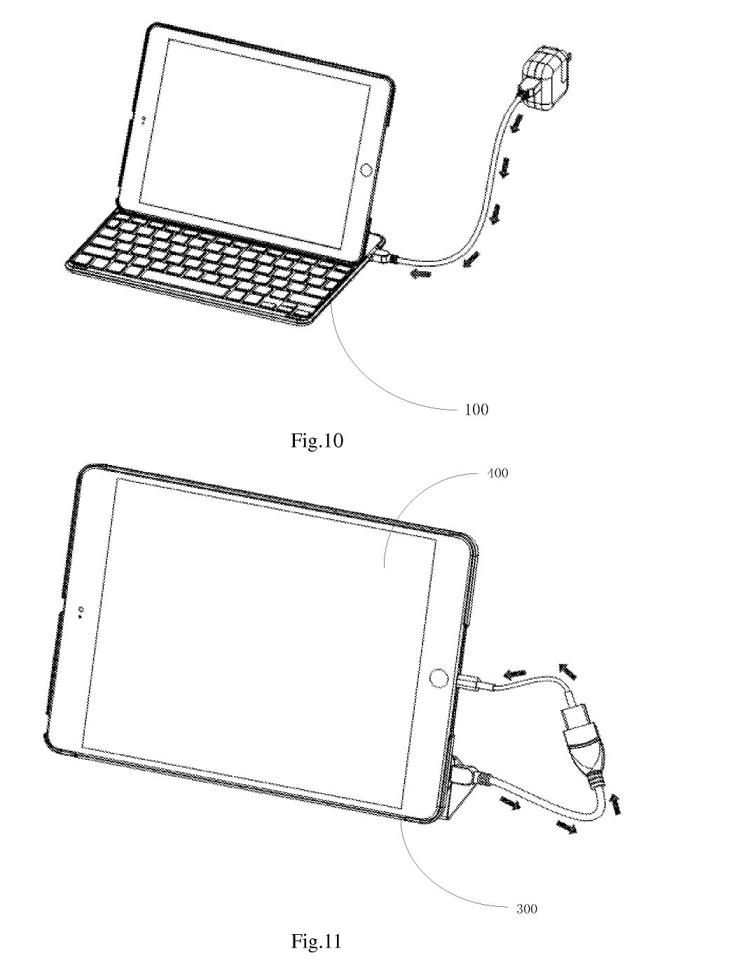

Accordingly, when implementing the Bluetooth keyboard of present application, the Bluetooth keyboard just needs one same interface for both supplying power to the external load and charging the built-in battery via the external power source. As shown in FIG. 9, the Bluetooth keyboard according to present application charges the external load 200 (such as a tablet PC, a mobile telephone and so on) via the interface. As shown in FIG. 9, the Bluetooth keyboard connects with an external power source for charging the Bluetooth keyboard via the interface.

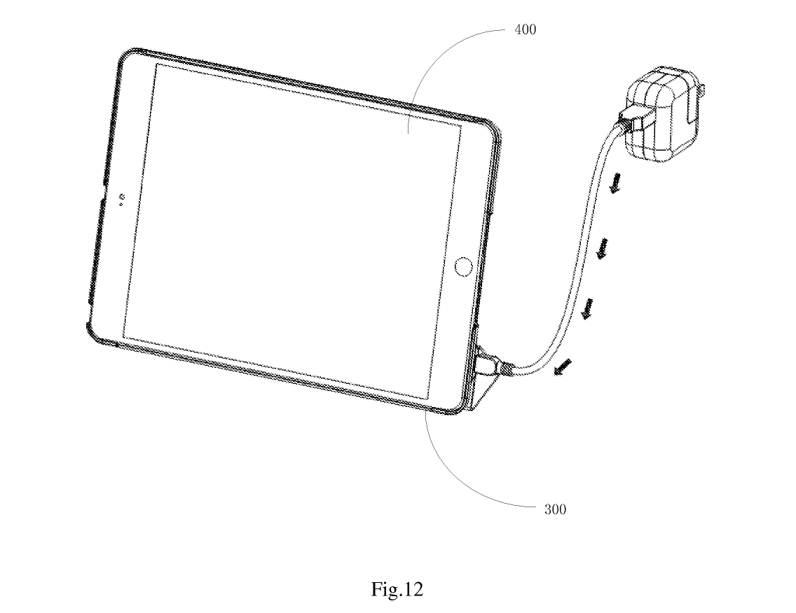

The present application further provides a protective sleeve, which can be a protective sleeve of a mobile telephone or a tablet PC. The protective sleeve comprises a protective sleeve body 300 arranged with above mobile power source with a single interface as shown in FIG. 1-6. Furthermore, the protective sleeve having above mobile power source with a single interface on one hand extends its original function, and on the other hand just needs one same interface for both supplying power to the external load and charging the built-in battery via the external power source. FIG. 11 illustrates the protective sleeve 300 according to present application charging the tablet PC 400 using the protective sleeve 300 via the single interface. FIG. 12 illustrates the external power source charging the protective sleeve 300 via the single interface shown in FIG. 11.

While the present application has been described with reference to certain embodiments, it will be understood by those skilled in the art that various changes may be made and equivalents may be substituted without departing from the scope of the present application. In addition, many modifications may be made to adapt a particular situation or material to the teachings of the present application without departing from its scope. Therefore, it is intended that the present application not be limited to the particular embodiment disclosed, but that the present application will include all embodiments falling within the scope of the appended claims.

What we claimed is:

1. A mobile power source with a single interface for charging a built-in battery and supplying power to an external load, wherein, the single interface comprising a power source terminal and a ground terminal;
wherein the mobile power source with a single interface comprising: a voltage detecting circuit (10) connecting with the power source terminal of the single interface for detecting a voltage of an external power source, a current detecting circuit (20) connecting with the ground terminal of the single interface for detecting a current of an external load, a microcontroller (U5), a charging controlling unit (30) and a power supplying control unit(40) connecting with an output terminal of the microcontroller (U5) separately; wherein, the voltage detecting circuit (10) and the current detecting circuit (20) connect with an input terminal of the microcontroller (U5);
wherein, the microcontroller (U5) is used for controlling the charging of the built-in battery via the charging controlling unit (30) when an access of the external power source is detected by the voltage detecting circuit (10) and for controlling the power supplying to the external load via the power supplying control unit (40) when an access of the external load is detected by the current detecting circuit (20).

2. The mobile power source with a single interface according to claim 1, wherein, the charging controlling unit (30) comprises a first switching unit (301) connecting with the microcontroller (U5) and a charging managing module (302) connecting with the first switching unit (301), wherein the microcontroller (U5) switches on the first switching unit (301) when the access of the external power source is detected by the voltage detecting circuit (10), and a voltage of the external power source accessed from the single interface charges the built-in battery via the charging managing module (302), wherein the power supplying control unit (40) comprises a second switching unit (401) and a boost circuit (402) both connected with the microcontroller (U5), wherein, the boost circuit (402) connects with the built-in battery and the second switching unit (401), the microcontroller (U5) switches on the second switching unit (401) and operates the boost circuit (402) for boosting a voltage of the built-in battery and supplying power to the external load connecting with the single interface via the second switching unit (401) when the access of the external load is detected by the current detecting circuit (20).

3. The mobile power source with a single interface according to claim 2, wherein, the microcontroller (U5) has a model of SH69P482.

4. The mobile power source with a single interface according to claim 3, wherein, the first switching unit (301) comprises a MOS transistor Q5, a triode Q6 and a resistor R24, wherein a base of the triode Q6 connects with a ninth pin of the microcontroller (U5), a collector of the triode Q6 connects with a grid of the MOS transistor Q5 and a source of the MOS transistor Q5 via the resistor R24, a drain of the MOS transistor Q5 connects with the charging managing module (302), and an emitter of the triode Q6 is grounded.

5. The mobile power source with a single interface according to claim 4, wherein, the boost circuit (402) comprises a control chip (U6) and an outputting circuit connected with the control chip (U6), wherein the outputting circuit comprises an inductor L1, a diode D3, a capacitor C15, a resistor R29 and a resistor R34, wherein a fourth pin of the control chip (U6) connects with a third pin of the microcontroller (U5), a first pin of the control chip (U6) connects with the built-in battery via the inductor L1 and meanwhile connects with an anode of the diode D3, a cathode of the diode D3 connects with one end of the capacitor C15 and one end of the resistor R29 separately, other end of the capacitor C15 is grounded, and other end of the resistor R29 is grounded via the resistor R34.

6. The mobile power source with a single interface according to claim 5, wherein, the control chip (U6) has a model of MT3608.

7. The mobile power source with a single interface according to claim 6, wherein, the second switching unit (401) comprises a MOS transistor Q7, a triode Q8 and a resistor R28, wherein a base of the triode Q8 connects with the third pin of the microcontroller (U5), a collector of the triode Q8 connects with a grid of the MOS transistor Q7 and one end of the resistor R28, other end of the resistor R28 connects with a source of the MOS transistor Q7 and the cathode of the diode D3 separately, a drain of the MOS transistor Q7 connects with the power source terminal of the single interface.

8. The mobile power source with a single interface according to claim 3, wherein, the voltage detecting circuit (10) comprises a resistor R17 and a resistor R23, wherein one end of the resistor R17 connects with the power source terminal of the single interface, and other end of the resistor R17 is grounded via the resistor R23, a connection node of the resistor R17 and the resistor R23 connects with a sixteenth pin of the microcontroller (U5).

9. The mobile power source with a single interface according to claim 3, wherein, the current detecting circuit (20) comprises a resistor ER9, a resistor R33 and a capacitor C16, wherein one end of the resistor ER9 connects with the ground terminal of the single interface, other end of the resistor ER9 is grounded via the resistor R33 and the capacitor C16 connected in series, a connection node of the resistor R33 and the capacitor C16 connects with a seventh pin of the microcontroller (U5).

10. A Bluetooth keyboard comprising a mobile power source with a single interface for charging a built-in battery and supplying power to an external load, wherein, the single interface comprising a power source terminal and a ground terminal;
wherein the mobile power source with a single interface comprising: a voltage detecting circuit (10) connecting with the power source terminal of the single interface for detecting a voltage of an external power source, a current detecting circuit (20) connecting with the ground terminal of the single interface for detecting a current of an external load, a microcontroller (U5), a charging controlling unit (30) and a power supplying control unit(40) connecting with an output terminal of the microcontroller (U5) separately; wherein, the voltage detecting circuit (10) and the current detecting circuit (20) connect with an input terminal of the microcontroller (U5);
wherein, the microcontroller (U5) is used for controlling the charging of the built-in battery via the charging controlling unit (30) when an access of the external power source is detected by the voltage detecting circuit (10) and for controlling the power supplying to the external load via the power supplying control unit (40) when an access of the external load is detected by the current detecting circuit (20).

11. The Bluetooth keyboard according to claim 10, wherein, the charging controlling unit (30) comprises a first switching unit (301) connecting with the microcontroller (U5) and a charging managing module (302) connecting with the first switching unit (301), wherein the microcontroller (U5) switches on the first switching unit (301) when the access of the external power source is detected by the voltage detecting circuit (10), and a voltage of the external power source accessed from the single interface charges the built-in battery via the charging managing module (302), wherein the power supplying control unit (40) comprises a second switching unit (401) and a boost circuit (402) both connected with the microcontroller (U5), wherein, the boost circuit (402) connects with the built-in battery and the second switching unit (401), the microcontroller (U5) switches on the second switching unit (401) and operates the boost circuit (402) for boosting a voltage of the built-in battery and supplying power to the external load connecting with the single interface via the second switching unit (401) when the access of the external load is detected by the current detecting circuit (20).

12. The Bluetooth keyboard according to claim 11, wherein, the first switching unit (301) comprises a MOS transistor Q5, a triode Q6 and a resistor R24, wherein a base of the triode Q6 connects with a ninth pin of the microcontroller (U5), a collector of the triode Q6 connects with a grid of the MOS transistor Q5 and a source of the MOS transistor Q5 via the resistor R24, a drain of the MOS transistor Q5 connects with the charging managing module (302), and an emitter of the triode Q6 is grounded.

13. The Bluetooth keyboard according to claim 11, wherein, the voltage detecting circuit (10) comprises a resistor R17 and a resistor R23, wherein one end of the resistor R17 connects with the power source terminal of the single interface, and other end of the resistor R17 is grounded via the resistor R23, a connection node of the resistor R17 and the resistor R23 connects with a sixteenth pin of the microcontroller (U5).

14. The Bluetooth keyboard according to claim 11, wherein, the current detecting circuit (20) comprises a resistor ER9, a resistor R33 and a capacitor C16, wherein one end of the resistor ER9 connects with the ground terminal of the single interface, other end of the resistor ER9 is grounded via the resistor R33 and the capacitor C16 connected in series, a connection node of the resistor R33 and the capacitor C16 connects with a seventh pin of the microcontroller (U5).

15. A protective sleeve comprising a protective sleeve body arranged with a mobile power source with a single interface for charging a built-in battery and supplying power to an external load, wherein, the single interface comprising a power source terminal and a ground terminal;
wherein the mobile power source with a single interface comprising: a voltage detecting circuit (10) connecting with the power source terminal of the single interface for detecting a voltage of an external power source, a current detecting circuit (20) connecting with the ground terminal of the single interface for detecting a current of an external load, a microcontroller (U5), a charging controlling unit (30) and a power supplying control unit(40) connecting with an output terminal of the microcontroller (U5) separately; wherein, the voltage detecting circuit (10) and the current detecting circuit (20) connect with an input terminal of the microcontroller (U5);
wherein, the microcontroller (U5) is used for controlling the charging of the built-in battery via the charging controlling unit (30) when an access of the external power source is detected by the voltage detecting circuit (10) and for controlling the power supplying to the external load via the power supplying control unit (40) when an access of the external load is detected by the current detecting circuit (20).

16. The protective sleeve according to claim 15, wherein, the charging controlling unit (30) comprises a first switching unit (301) connecting with the microcontroller (U5) and a charging managing module (302) connecting with the first switching unit (301), wherein the microcontroller (U5) switches on the first switching unit (301) when the access of the external power source is detected by the voltage detecting circuit (10), and a voltage of the external power source accessed from the single interface charges the built-in battery via the charging managing module (302), wherein the power supplying control unit (40) comprises a second switching unit (401) and a boost circuit (402) both connected with the microcontroller (U5), wherein, the boost circuit (402) connects with the built-in battery and the second switching unit (401), the microcontroller (U5) switches on the second switching unit (401) and operates the boost circuit (402) for boosting a voltage of the built-in battery and supplying power to the external load connecting with the single interface via the second switching unit (401) when the access of the external load is detected by the current detecting circuit (20).

17. The protective sleeve according to claim 16, wherein, the first switching unit (301) comprises a MOS transistor Q5, a triode Q6 and a resistor R24, wherein a base of the triode Q6 connects with a ninth pin of the microcontroller (U5), a collector of the triode Q6 connects with a grid of the MOS transistor Q5 and a source of the MOS transistor Q5 via the resistor R24, a drain of the MOS transistor Q5 connects with the charging managing module (302), and an emitter of the triode Q6 is grounded.

18. The protective sleeve according to claim 17, wherein, the boost circuit (402) comprises a control chip (U6) and an outputting circuit connected with the control chip (U6), wherein the outputting circuit comprises an inductor L1, a diode D3, a capacitor C15, a resistor R29 and a resistor R34, wherein a fourth pin of the control chip (U6) connects with a third pin of the microcontroller (U5), a first pin of the control chip (U6) connects with the built-in battery via the inductor L1 and meanwhile connects with an anode of the diode D3, a cathode of the diode D3 connects with one end of the capacitor C15 and one end of the resistor R29 separately, other end of the capacitor C15 is grounded, and other end of the resistor R29 is grounded via the resistor R34, the control chip (U6) has a model of MT3608; the second switching unit (401) comprises a MOS transistor Q7, a triode Q8 and a resistor R28, wherein a base of the triode Q8 connects with the third pin of the microcontroller (U5), a collector of the triode Q8 connects with a grid of the MOS transistor Q7 and one end of the resistor R28, other end of the resistor R28 connects with a source of the MOS transistor Q7 and the cathode of the diode D3 separately, a drain of the MOS transistor Q7 connects with the power source terminal of the single interface.

19. The protective sleeve according to claim 16, wherein, the voltage detecting circuit (10) comprises a resistor R17 and a resistor R23, wherein one end of the resistor R17 connects with the power source terminal of the single interface, and other end of the resistor R17 is grounded via the resistor R23, a connection node of the resistor R17 and the resistor R23 connects with a sixteenth pin of the microcontroller (U5).

20. The protective sleeve according to claim 16, wherein, the current detecting circuit (20) comprises a resistor ER9, a resistor R33 and a capacitor C16, wherein one end of the resistor ER9 connects with the ground terminal of the single interface, other end of the resistor ER9 is grounded via the resistor R33 and the capacitor C16 connected in series, a connection node of the resistor R33 and the capacitor C16 connects with a seventh pin of the microcontroller (U5).
